(19) United States
(12) Patent Application Publication
(10) Pub. No.: US 2026/0126921 A1
(43) Pub. Date: May 7, 2026

(54) METHODS AND APPARATUSES FOR OPERATING MEMORY SYSTEMS

(71) Applicant: Yangtze Memory Technologies Co., Ltd., Wuhan (CN)

(72) Inventors: Hao HE, Wuhan (CN); Hua TAN, Wuhan (CN)

(21) Appl. No.: 19/023,759

(22) Filed: Jan. 16, 2025

Related U.S. Application Data
(63) Continuation of application No. PCT/CN2024/129625, filed on Nov. 4, 2024.

(51) Int. Cl. G06F 3/06

(52) U.S. Cl. CPC G06F 3/0623; G06F 3/061; G06F 3/0652; G06F 3/0679

(57) ABSTRACT

Methods, devices, apparatuses, and systems for operating memory systems are provided. In one aspect, a memory system includes a memory device including a plurality of memory blocks, and a memory controller coupled to the memory device. The memory controller is configured to identify a first memory block of the plurality of memory blocks, where the first memory block includes specific data that is invalid. The memory controller can be configured to increase a priority level of the first memory block among the plurality of memory blocks, and perform garbage collection on the memory device based on priority levels of the plurality of memory blocks.

### CROSS-REFERENCE TO RELATED APPLICATIONS

This application is a continuation of International Application No. PCT/CN2024/129625, filed on Nov. 4, 2024, the disclosure of which is hereby incorporated by reference in its entirety.

### TECHNICAL FIELD

The present disclosure generally relates to memory devices and memory systems, and in particular, to operating memory systems.

### BACKGROUND

Flash memory is a low-cost, high-density, nonvolatile solid-state storage medium that can be electrically erased and reprogrammed. Flash memory includes NOR flash memory and NAND flash memory. Various operations can be performed by a flash memory, for example, program (write) or read operations. Operations performed by a flash memory can affect temperature of the flash memory.

### SUMMARY

The present disclosure involves methods, apparatuses, and systems for operating a memory system, e.g., managing purge commands in the memory system.

One aspect of the present disclosure provides a memory device including a plurality of memory blocks, and a memory controller coupled to the memory device. The memory controller is configured to identify a first memory block of the plurality of memory blocks, where the first memory block includes specific data that is invalid. The memory controller is further configured to increase a priority level of the first memory block among the plurality of memory blocks, and perform garbage collection on the memory device based on priority levels of the plurality of memory blocks.

In some implementations, the specific data includes replay-protected-memory-block (RPMB) data.

In some implementations, the specific data becomes invalid when new data is written to a same logical address as the specific data.

In some implementations, the memory controller is configured to identify the first memory block by checking an indication bit corresponding to the first memory block. The indication bit indicates whether the first memory block includes the specific data that is invalid.

In some implementations, the memory controller is configured to increase the priority level of the first memory block by decreasing a first valid page count (VPC) of the first memory block, and perform a first garbage collection operation on the first memory block before a second memory block having a second VPC that is greater than the first VPC.

In some implementations, the memory controller is configured to receive a purge command to erase invalid specific data in the memory device, and send a response indicating that the invalid specific data in the memory device has been erased.

In some implementations, the memory controller is configured to erase the invalid specific data in a corresponding memory block during the garbage collection before receiving the purge command.

In some implementations, the memory controller is configured to perform the garbage collection on the memory device while the memory device is idle.

In some implementations, the memory controller is configured to perform a first garage collection operation on the first memory block by sending one or more commands to migrate valid data from the first memory block to a target memory block of the memory device and erase the first memory block.

Another aspect of the present disclosure features a memory controller. The memory controller includes a processor, and a first interface coupled to a memory device. The processor is configured to perform garbage collection on the memory device based on priority levels of a plurality of memory blocks in the memory device. The first interface is configured to send one or more read commands to read valid data from a first memory block of the plurality of memory blocks. The first memory block includes specific data that is invalid. Among the plurality of memory blocks, the first memory block has an increased priority level based on the first memory block including the specific data that is invalid. The first interface is further configured to send one or more write commands to write the valid data read from the first memory block to a target memory block of the memory device.

In some implementations, the processor is configured to identify the first memory block from the plurality of memory blocks, and increase a priority level of the first memory block among the plurality of memory blocks.

In some implementations, the processor is configured to increase the priority level of the first memory block by decreasing a first valid page count (VPC) of the first memory block, and perform a first garbage collection operation on the first memory block before a second memory block having a second VPC that is greater than the first VPC.

In some implementations, the memory controller includes a second interface coupled to a host. The second interface is configured to receive a purge command to erase invalid specific data in the memory device, and send a response indicating that the invalid specific data in the memory device have been erased.

In some implementations, the processor is configured to erase the invalid specific data in a corresponding memory block during the garbage collection before receiving the purge command.

In some implementations, the processor is configured to perform the garbage collection on the memory device while the memory device is idle.

In some implementations, the specific data includes replay-protected-memory-block (RPMB) data.

In some implementations, the specific data becomes invalid when new data is written to a same logic address as the specific data.

In some implementations, the processor is configured to identify the first memory block by checking an indication bit corresponding to the first memory block. The indication bit indicates whether the first memory block includes the specific data that is invalid.

In some implementations, the processor is configured to perform a first garage collection operation on the first memory block by sending one or more commands to migrate valid data from the first memory block to a target memory block of the memory device and erase the first memory block.

Another aspect of the present disclosure features a method of operating a memory system. The method includes identifying a first memory block of a plurality of memory blocks of a memory device of the memory system, where the first memory block includes specific data that is invalid, increasing a priority level of the first memory block among the plurality of memory blocks, and performing garbage collection on the memory device based on priority levels of the plurality of memory blocks.

Another aspect of the present disclosure features a non-transitory, computer-readable medium. The non-transitory, computer-readable medium stores one or more instructions executable by a memory system to perform operations including identifying a first memory block of a plurality of memory blocks of a memory device of the memory system, where the first memory block includes specific data that is invalid, increasing a priority level of the first memory block among the plurality of memory blocks, and performing garbage collection on the memory device based on priority levels of the plurality of memory blocks.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system having a memory device.

FIGS. 2A-2B illustrate example storage products.

FIG. 3 illustrates an example of a schematic diagram of an example memory device.

FIG. 4 illustrates some example peripheral circuits.

FIG. 5A illustrates a block diagram of an example memory system including an example memory controller.

FIG. 5B illustrates a block diagram of an example memory controller.

FIG. 6 illustrates a swimlane diagram of an example process of processing a purge command.

FIG. 7 illustrates example techniques to identify a memory block that includes invalid replay-protected-memory-block (RPMB) data.

FIG. 8 illustrates example techniques to perform garbage collection based on priority levels of memory block.

FIG. 9 illustrates a swimlane diagram of another example process of processing a purge command.

Like reference numbers and designations in the various drawings indicate like elements.

### DETAILED DESCRIPTION

This present disclosure relates to memory devices, memory systems, and methods for processing purge commands. Replay-protected-memory-block (RPMB) data is a type of secure data that requires authentication when accessing. A host can store sensitive and important information in a memory device as RPMB data. To further ensure the security of RPMB data, the host can send a purge command to physically erase RPMB data that has become invalid in the memory device. In some cases, to process the purge command, the memory device needs to migrate valid data from the memory blocks having invalid RPMB data to other memory blocks before erasing the memory blocks, which may take a long time.

Implementations of the present disclosure provide techniques to reduce the time for processing purge commands. In some implementations, a memory controller can be configured to identify memory blocks having invalid RPMB data, and increase priority levels of such memory blocks, e.g., by decreasing valid page counts (VPC) of such memory blocks. The memory controller can be configured to perform garbage collection on the memory device based on priority levels of a plurality of memory blocks in the memory device. The garbage collection can be performed while the memory device is idle and/or before receiving a purge command. Since the memory blocks having invalid RPMB data have increased priority levels, more invalid RPMB data can be erased during the garbage collection, so that less invalid RPMB data remains to be erased when the memory controller receives the purge command.

The described techniques can achieve one or more technical effects (e.g., technical advantages and/or benefits). For example, when the memory controller receives the purge command, there is less invalid RPMB data remaining to be erased, compared to the scenario where priority levels of the memory blocks having invalid RPMB data are unchanged. As such, the time to process the purge command can be reduced. For another example, compared to the scenario where the memory device allocates certain memory blocks to store only RPMB data, the described techniques allow RPMB data to be stored in the same memory blocks as normal data, which utilizes memory space in the memory device in a more efficient way. Further, the described techniques require no hardware changes and little firmware change in the memory controller, which is cost-effective. In some implementations, additional or different technical effects can be achieved.

The techniques can be applied to various types of semiconductor devices, e.g., non-volatile memory (NVM) devices (such as NAND flash memory or NOR flash memory), volatile memory devices (such as DRAM memory devices), resistive random-access memory (RRAM), phase-change memory (PCM) such as phase-change random-access memory (PCRAM), spin-transfer torque (STT)-Magnetoresistive random-access memory (MRAM), among others. The techniques can also be applied to charge-trapping based memory devices, e.g., silicon-oxide-nitride-oxide-silicon (SONOS) memory devices, and floating-gate based memory devices. The techniques can be applied to three-dimensional (3D) memory devices. The techniques can be applied to various memory types, such as SLC (single-level cell) devices, MLC (multi-level cell) devices like 2-level cell devices, TLC (triple-level cell) devices, QLC (quad-level cell) devices, or PLC (penta-level cell) devices. Additionally or alternatively, the techniques can be applied to various types of devices and systems, such as secure digital (SD) cards, embedded multimedia cards (eMMC), universal flash storage (UFS), or solid-state drives (SSDs), embedded systems, among others.

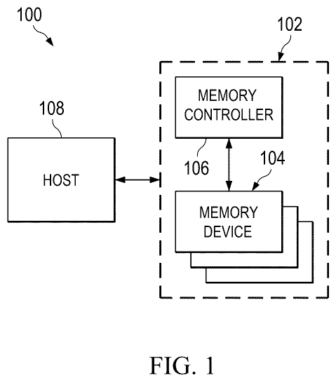

FIG. 1 illustrates a block diagram of an example system 100 having a memory device, according to some aspects of the present disclosure. The system 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1, the system 100 can include a host 108 and a memory system 102 having one or more memory devices 104 and a memory controller 106. The host 108 can include one or more processors of an electronic device. The processor can be a central processing unit (CPU), or a system-on-chip (SoC), such as an application processor (AP). The host 108 can be configured to send or receive data and commands to or from the memory systems 102.

The memory device 104 can be any memory device disclosed in the present disclosure, such as a NAND Flash memory device. It is noted that the NAND Flash is only one example of memory device for illustrative purposes. It can include any suitable solid-state, non-volatile memory, e.g., NOR Flash, Ferroelectric RAM (FeRAM), Phase-change memory (PCM), Magneto-resistive random-access memory (MRAM), Spin-transfer torque magnetic random-access memory (STT-RAM), or Resistive random-access memory (RRAM), etc. In some implementations, memory device 104 includes a three-dimensional (3D) NAND Flash memory device.

The memory controller 106 can be implemented by microprocessors, microcontrollers (a.k.a. microcontroller units (MCUs)), digital signal processors (DSPs), application-specific integrated circuits (ASICs), field-programmable gate arrays (FPGAs), programmable logic devices (PLDs), state machines, gated logic, discrete hardware circuits, and other suitable hardware, firmware, and/or software configured to perform the various functions described below in detail.

The memory controller 106 is coupled to the memory device 104 and to the host 108, and is configured to control the memory device 104, according to some implementations. The memory controller 106 can manage the data stored in the memory device 104 and can communicate with the host 108. In some implementations, the memory controller 106 is designed for operating in a low duty-cycle environment, such as secure digital (SD) cards, compact Flash (CF) cards, universal serial bus (USB) Flash drives, or other media for use in electronic devices, such as personal computers, digital cameras, mobile phones, etc. In some implementations, memory controller 106 is designed for operating in a high duty-cycle environment solid state drives (SSDs) or embedded multi-media-cards (eMMCs) used as data storage for mobile devices, such as smartphones, tablets, laptop computers, etc., and enterprise storage arrays. The memory controller 106 can be configured to control operations of the memory device 104, such as read, erase, and program operations. The memory controller 106 can also be configured to manage various functions with respect to the data stored or to be stored in the memory device 104 including, but not limited to bad-block management, garbage collection, logical-to-physical address conversion, logical-to-physical mapping management, wear leveling, etc. In some implementations, the memory controller 106 is further configured to process error correction codes (ECCs) with respect to the data read from or written to the memory device 104. Any other suitable functions can be performed by the memory controller 106 as well, for example, formatting the memory device 104.

The memory controller 106 can communicate with an external device (e.g., the host 108) according to a particular communication protocol. For example, the memory controller 106 can communicate with the external device by one or more interfaces by at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc. The memory controller 106 is configured to receive and transmit a command to and from the host 108, and execute or perform multiple functions and operations provided in the present disclosure, which will be described later.

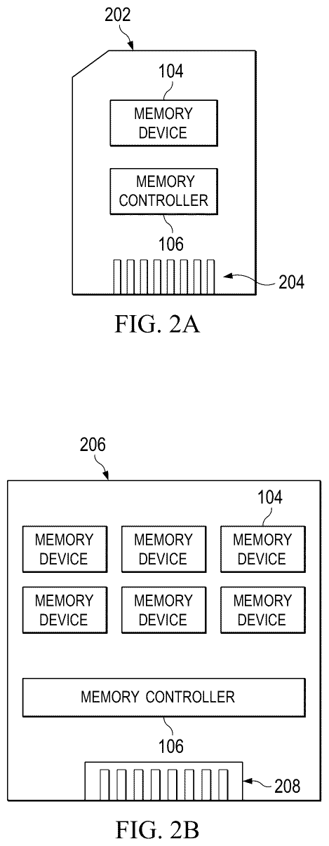

The memory controller 106 and the one or more memory devices 104 can be integrated into various types of storage devices. For example, the memory controller 106 and the one or more memory devices 104 can be packaged in a universal Flash storage (UFS) package or an eMMC package. In one example as shown in FIG. 2A, the memory controller 106 and a single memory device 104 can be integrated into a memory card 202. The memory card 202 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. The memory card 202 can further include a memory card connector 204 coupling the memory card 202 with a host (e.g., host 108 in FIG. 1). In another example as shown in FIG. 2B, the memory controller 106 and multiple memory devices 104 can be integrated into an SSD 206. The SSD 206 can further include an SSD connector 208 that couples the SSD 206 with a host (e.g., host 108 in FIG. 1). In some implementations, the storage capacity and/or the operation speed of the SSD 206 is greater than those of the memory card 202.

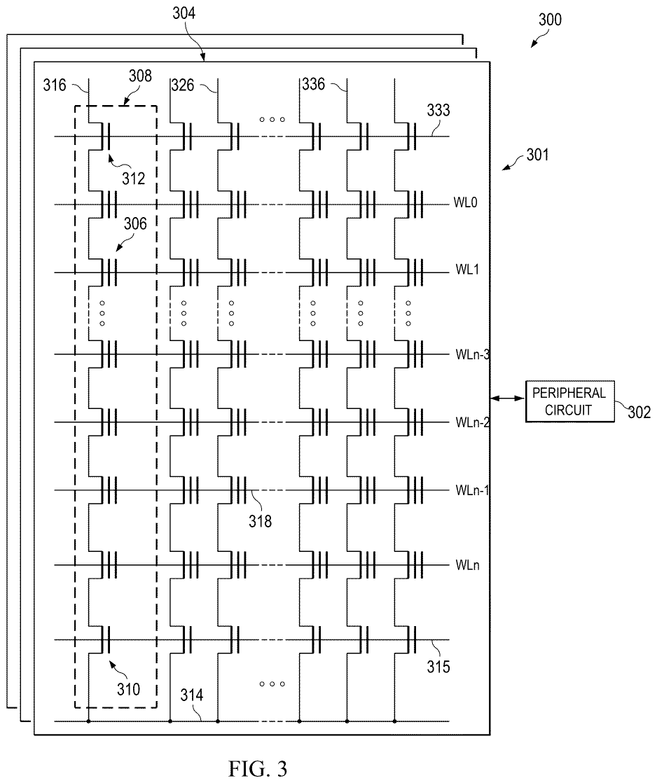

FIG. 3 illustrates an example of a schematic diagram of a memory device 300 including peripheral circuits, according to some aspects of the present disclosure. The memory device 300 can include a memory cell array 301 and peripheral circuits 302 coupled to the memory cell array 301. The memory cell array 301 can be a NAND Flash memory cell array in which memory cells 306 are provided in the form of an array of memory strings 308 each extending vertically above a substrate (not shown in FIG. 3). In some implementations, each memory string 308 includes a plurality of memory cells 306 coupled in series and stacked vertically. Each memory cell 306 can hold a continuous, analog value, such as an electrical voltage or charge that depends on the number of electrons trapped within a storage layer of the memory cell 306. The logic state (i.e., data) of each memory cell 306 in a memory block 304 can be determined based on the threshold voltage Vth of the memory cell 306. Each memory cell 306 can be a floating gate type memory cell including a floating-gate transistor, or a charge trap type memory cell including a charge-trap transistor.

In some implementations, each memory cell 306 is a single-level cell (SLC) with two possible memory states that can store one bit of data. For example, the first memory state “0” can correspond to a first range of voltages, and the second memory state “1” can correspond to a second range of voltages. In some implementations, each memory cell 306 is a multi-level cell (MLC) that is capable of storing more than one bit of data in more than two memory states. For example, the MLC can store two bits per cell, three bits per cell (also known as triple-level cell (TLC)), or four bits per cell (also known as a quad-level cell (QLC)). Each MLC can be programmed to support a range of possible nominal storage values. In one example, if each MLC stores two bits of data, then the MLC can be programmed to one of three possible programming levels from an erased state by writing one of three possible nominal storage values to the cell. A fourth nominal storage value can be used for the erased state.

As shown in FIG. 3, each memory string 308 can include a source select gate (SSG) 310 at its source end and a drain select gate (DSG) 312 at its drain end. The SSG 310 and the DSG 312 can be configured to activate selected memory strings 308 (columns of the array) during read and program operations. In some implementations, the sources of memory strings 308 in the same memory block 304 are coupled through a same source line (SL) 314, e.g., a common SL. In other words, memory strings 308 in the same memory block 304 have an array common source (ACS), according to some implementations. The DSG 312 of each memory string 308 is coupled to a respective bit line 316 from which data can be read or written via an output bus (not shown), according to some implementations. In some implementations, each memory string 308 is configured to be selected or deselected by applying a select voltage (e.g., above the threshold voltage of the transistor having the DSG 312) or a deselect voltage (e.g., 0 V) to the respective DSG 312 through one or more DSG lines 313, and/or by applying a select voltage (e.g., above the threshold voltage of the transistor having the SSG 310) or a deselect voltage (e.g., 0 V) to the respective SSG 310 through one or more SSG lines 315.

As shown in FIG. 3, memory strings 308 can be organized into multiple memory blocks 304, each of which can have a common SL 314 coupled to the ACS. In some implementations, each memory block 304 can serve as a basic data unit for erase operations, such that memory cells 306 on the same memory block 304 are erased at the same time. To erase memory cells 306 in a selected memory block 304, the SL 314 coupled to the selected memory block 304 and unselected memory blocks in the same plane can be biased with an erase voltage. For example, the erase voltage can be a high positive voltage (e.g., 20 V or more). In some implementations, an erase operation can be performed at a half-block level, a quarter-block level, or a level having any suitable number of memory blocks or fractions of a memory block.

The memory cells 306 of adjacent memory strings 308 can be coupled through word lines 318. The word line 318 can select which row of memory cells 306 is affected by read and program operations. Each word line 318 can include a gate line coupled to a plurality of control gates (gate electrodes) of a plurality of memory cells 306. Example word lines shown in FIG. 3 are between one or more DSG lines 313 and one or more SSG lines 315.

In some implementations, the memory cells 306 of adjacent memory strings 308 can be coupled through word lines 318. The word line 318 can select which row of memory cells 306 is affected by read and program operations. In some implementations where memory cells 306 are SLCs, one row of memory cells 306 can store one logical page of data, and therefore corresponds to one logical page. In some implementations where memory cells 306 are MLCs, one row of memory cells 306 can store two logical pages of data, and therefore corresponds to two logical pages. In some implementations where memory cells 306 are TLCs, one row of memory cells 306 can store three logical pages of data, and therefore corresponds to three logical pages. In some implementations where memory cells 306 are QLCs, one row of memory cells 306 can store four logical pages of data, and therefore corresponds to four logical pages.

Each word line 318 can include a gate line coupled to a plurality of control gates (gate electrodes) of a plurality of memory cells 306. Example word lines shown in FIG. 3 include WL0, WL1, . . . , WLn−2, WLn−1, and WLn that are between DSG line 313 and SSG line 315. In some implementations, the word lines can further include dummy word lines coupled to dummy memory cells.

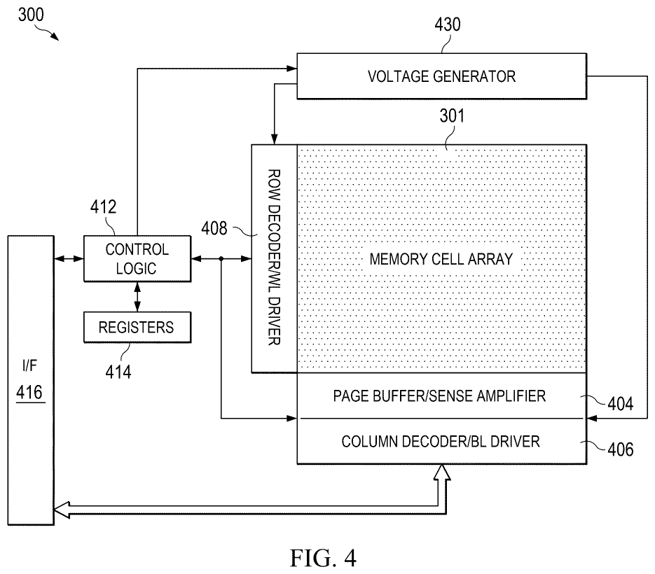

FIG. 4 illustrates some example peripheral circuits 302, according to some aspects of the present disclosure. The peripheral circuits 302 can be coupled to the memory cell array 301 through bit lines 316, word lines 318, SLs 314, SSG lines 315, and DSG lines 313. The peripheral circuits 302 can include any suitable analog, digital, and mixed-signal circuits for facilitating the operations of the memory cell array 301 by applying and sensing voltage signals and/or current signals to and from each target memory cell 306 through bit lines 316, word lines 318, SLs 314, SSG lines 315, and DSG lines 313. The peripheral circuits 302 can include various types of peripheral circuits formed using metal-oxide-semiconductor (MOS) technologies. The example peripheral circuits 302 include a page buffer/sense amplifier 404, a column decoder/bit line driver 406, a row decoder/word line driver 408, a voltage generator 410, control logic 412, registers 414, an interface 416, and a data bus. In some examples, additional peripheral circuits not shown in FIG. 4 may be included as well.

The page buffer/sense amplifier 404 can be configured to read and program (write) data from and to memory cell array 301 according to the control signals from control logic 412. In an example, the page buffer/sense amplifier 404 may store one page of program data (write data) to be programmed into the memory cell array 301. In another example, the page buffer/sense amplifier 404 may perform program verify operations to ensure that the data have been properly programmed into memory cells 306 coupled to selected word lines 318. In still another example, the page buffer/sense amplifier 404 may also sense the low power signals from the bit line 316 that represents a data bit stored in memory cell 306, and amplify the small voltage swing to recognizable logic levels in a read operation. The column decoder/bit line driver 406 can be configured to be controlled by the control logic 412 and select one or more memory strings 308 by applying bit line voltages generated from the voltage generator 410.

The row decoder/word line driver 408 can be configured to be controlled by the control logic 412 and select/deselect memory blocks 304 of the memory cell array 301 and select/deselect word lines 318 of the memory block 304. The row decoder/word line driver 408 can be further configured to drive word lines 318 using word line voltages generated from the voltage generator 410. In some implementations, the row decoder/word line driver 408 can also select/deselect and drive SSG lines 315 and DSG lines 313. As described below in detail, the row decoder/word line driver 408 is configured to apply a program voltage to selected word line 318 in a program operation on memory cell 306 coupled to selected word line 318.

The voltage generator 410 can be configured to be controlled by the control logic 412 and generate the word line voltages (e.g., read reference voltage, program voltage, pass voltage, local voltage, verify voltage, etc.), bit line voltages, and source line voltages to be supplied to the memory cell array 301.

The control logic 412 can be coupled to each peripheral circuit described above and configured to control operations of each peripheral circuit. The registers 414 can be coupled to the control logic 412 and include status registers, command registers, and address registers for storing status information, command operation codes (OP codes), and command addresses for controlling the operations of each peripheral circuit.

The interface 416 can be coupled to the control logic 412 and act as a control buffer to buffer and relay control commands received from a host (not shown) to the control logic 412 and status information received from the control logic 412 to the host. The interface 416 can also be coupled to the column decoder/bit line driver 406 via a data bus, and act as a data input/output (I/O) interface and a data buffer to buffer and relay data to and from the memory cell array 301.

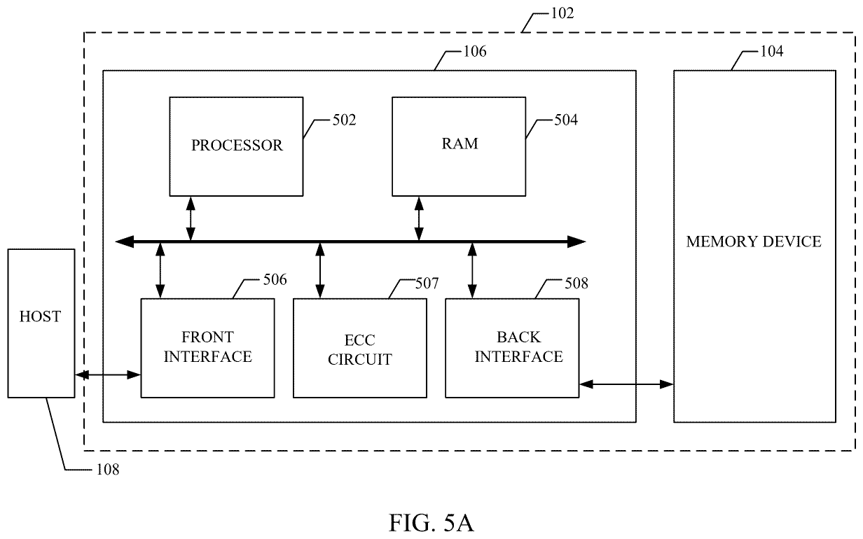

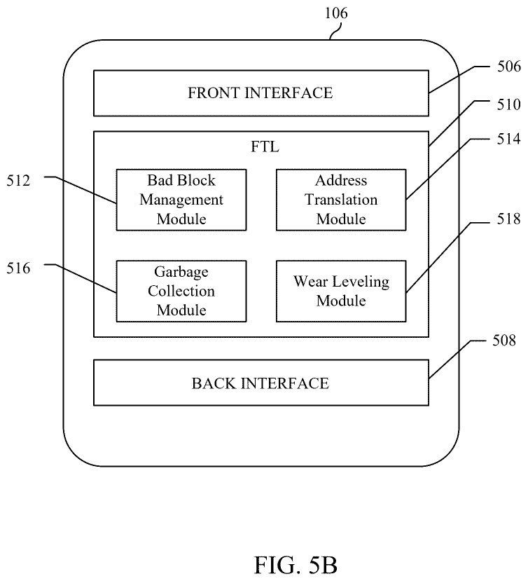

FIG. 5A is a block diagram of an example memory system 102 including an example memory controller 106. The memory system 102 further includes a memory device 104. The memory system can be coupled to a host 108.

The memory controller 106 is configured to operate the memory device 104 at the request of the host 108. The memory controller 106 is configured to drive firmware for controlling the operations of the memory device 104. The memory controller 106 can include a random access memory (RAM) 504, a processor 502, a front interface 506, an error-correction code (ECC) circuit 507, and a back interface 508.

The memory controller 106 is configured to communicate with the host 108 through the front interface 506. For example, the memory controller 106 can receive commands from the host 108 and send responses to the host 108 through the front interface 506. The memory controller 106 is configured to communicate with the memory device 104 through the back interface 508. For example, the memory controller 106 can send commands to the memory device 104 and receive responses from the memory device 104 through the back interface 508. The back interface 508 may include a NAND flash interface or a NOR flash interface.

The ECC circuit 507 is configured to process error correction codes with respect to the data read from or written to the memory device 104. Example error correction codes can include, but are not limited to, Hamming codes, Reed-Solomon codes, low-density parity check (LDPC) codes, etc. In some implementations, the ECC circuit 507 includes an LPDC encoder configured to generate parity data based on LDPC codes for user data received from the host 108, so that both the user data and the parity data can be sent to the memory device 104 for storage. The ECC circuit 507 can further include an LDPC decoder configured to decode data comprising the user data and the parity data. The ECC circuit can determine whether data stored in the block is read successfully (e.g., with no errors). If the data stored in the block is read successfully, the back interface 508 can forward the data to the front interface 506, so that the front interface 506 can return the data to the host 108. However, if the data stored in the memory block is not read successfully, the back interface 508 can generate data describing a read error on the memory block.

The RAM 504 is configured to be used as an operation memory of the processor 502, a cache memory between the memory device 104 and the host 108, and/or a buffer memory between the memory device 104 and the host 108.

The processor 502 is configured to control operations of the memory controller 106. The processor 502 is configured to control a read operation, a program operation, an erase operation, or other operations of the memory device 104. In some implementations, the processor 502 can function as a flash translation layer (FTL) 510.

As shown in FIG. 5B, the FTL 510 can include a bad block management module 512, an address translation module 514, a garbage collection (GC) module 516, and a wear leveling module 518. In some implementations, the FTL 510 can include other modules not shown in FIG. 5B.

The bad block management module 512 can be configured to identify failed memory blocks (e.g., by maintaining a bad block table) in the memory device 104. In some implementations, a memory block (e.g., memory block 304 of FIG. 3) may fail due to various factors including manufacturing defects, wear from repeated use, or physical damage. A failed memory block can be skipped or replaced in read or program operations to prevent data corruption.

The address translation module 514 can be configured to translate or map logical data blocks (e.g., received from the host 108) to physical spaces in the memory device 104. In some implementations, the address translation module 514 can translate a logical block address (LBA) provided by the host 108 into a physical block address (PBA) based on a logical to physical (L2P) mapping table. There may be various address mapping methods for the address translation module 514. Examples of address mapping methods include a page mapping method, a block mapping method, and a hybrid mapping method.

The GC module 516 can be configured to migrate data from a source memory block to a target memory block, so that the source memory block can be erased to be available for writing new data. For example, the GC module 516 can be configured to select a source memory block and a target memory block in the memory device 104, read valid data from the source memory block by sending read commands to the memory device 104, write the valid data to the target memory block by sending write commands to the memory device 104, and then erase the source memory block. In some implementations, the GC module 516 can be configured to perform foreground garbage collection on the memory device 104, where the garbage collection is performed when there are not enough memory blocks available for writing new data. In some implementations, the GC module 516 can perform background garbage collection on the memory device 104, where the garbage collection is performed while the memory device is idle (e.g., when there is no pending command to be executed by the memory device).

In some implementations, the GC module 516 performs garbage collection on the memory device 104 based on priority levels of memory blocks in the memory device 104. The priority level can be determined based on valid page count (VPC) of the memory blocks, erase/program (E/P) cycles that the memory blocks have undergone, and/or other metrics. For example, the garbage collection can migrate data from a first memory block having a smaller VPC (which indicates the first memory block has more invalid data) and erases the first memory block, before migrating data from a second memory block having a greater VPC and erasing the second memory block.

The wear leveling module 518 can be configured to balance E/P cycles across memory blocks. For example, the wear leveling module 518 can track the E/P cycle count of each memory block, and write new data to the least-used memory block first. For another example, the wear leveling module 518 can move cold data (data that are not frequently accessed) to another memory block to ensure that different memory blocks wear out at similar rates.

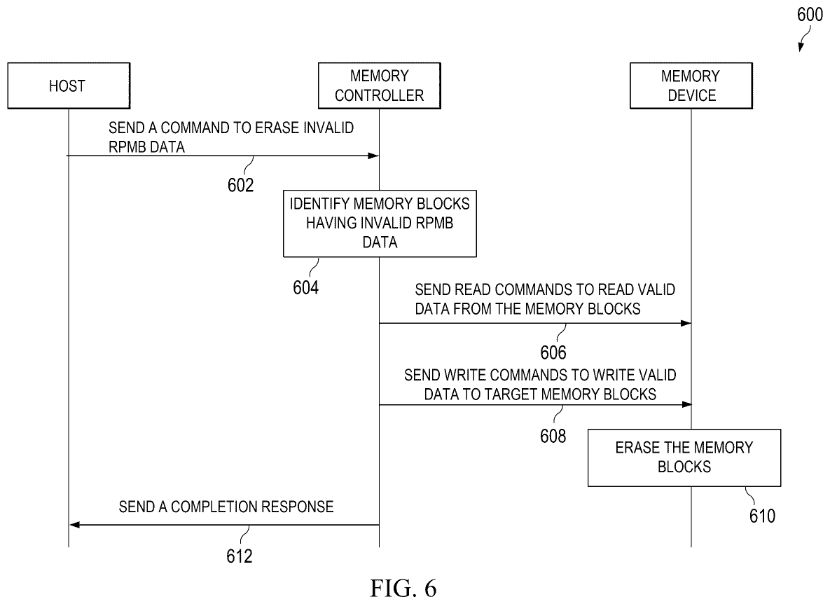

FIG. 6 illustrates a swimlane diagram of an example process 600 of processing a command, such as a purge command. The example process 600 can be performed by a memory system (e.g., the memory system 102 of FIG. 1) coupled to a host (e.g., the host 108 of FIGS. 1 and 5A). The memory system can include a memory controller (e.g., the memory controller 106 of FIGS. 1-2B and 5A-5B) and a memory device (e.g., the memory device 104 of FIGS. 1-2B and 5A, and the memory device 300 of FIGS. 3-4) including memory blocks (e.g., memory blocks 304 of FIG. 3).

At 602, the host sends a command that indicates to physically erase certain invalid data in the memory device. For example, the command can be a purge command. When data is written into the memory device, the logical address (e.g., LBA) of the data is mapped to a physical address (e.g., PBA) of the physical space where the data is stored. When new data is written to replace the previous data, the new data is associated with the same logical address, where the logical address is unmapped from the previous physical address and mapped to a physical address where the new data is stored. As such, data at the previous physical address becomes invalid when new data is written to the same logical address.

In some implementations, the command (e.g., purge command) indicates to physically erase specific data (e.g., secure data, authentication data, or priority data) that is invalid. In the process 600, as an example, the command indicates to physically erase replay-protected-memory-block (RPMB) data that is invalid. RPMB data is a type of secure data that can be safely stored in memory devices such as eMMC or UFS memory devices. Sensitive information, such as public keys related to fingerprint payments, serial numbers, passwords, authentication credentials, etc., can be stored as RPMB data in the memory devices.

At 604, the memory controller identifies memory blocks that have invalid RPMB data as source memory blocks. The memory device needs to perform erase operations on the source memory blocks to physically erase invalid RPMB data. In some implementations, RPMB data and normal data are mixedly stored. That is, a memory block may store both RPMB data and normal data. Since erase operations are usually performed on a block level, the memory device needs to migrate data (e.g., normal data) that is valid from the source memory blocks to other memory blocks (referred to as target memory blocks), before erasing the invalid RPMB data by performing erase operations on the source memory blocks.

At 606, the memory controller sends one or more read commands to read valid data from the source memory blocks. In response to receiving the one or more read commands, the memory device sends the valid data to the memory controller.

At 608, the memory controller sends one or more write commands to write the valid data to one or more target memory blocks (e.g., free memory blocks). In response to receiving the one or more write commands, the memory device programs the valid data into the one or more target memory blocks.

At 610, the memory device erases the source memory blocks. As such, the invalid RPMB data is physically erased.

At 612, the memory controller sends a response to inform the host that the invalid RPMB data has been erased, and that the command (e.g., the purge command) is completed.

In some cases, when the purge command is still in process (e.g., between operations 602 and 612), other commands received by the memory system may be delayed or rejected. The memory system may need a long time to process the purge command by erasing invalid RPMB data in multiple memory blocks, which may pause normal operations of the memory system for a long time. In some cases, the purge command can be performed during background garbage collection on the memory device, where the garbage collection is performed while the memory device is idle (e.g., when there is no pending command to be executed by the memory device).

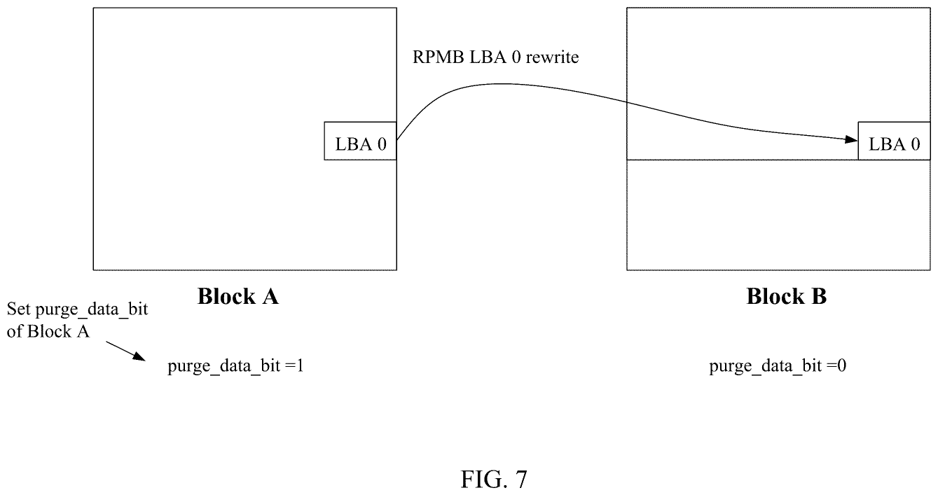

FIG. 7 illustrates example techniques to identify a memory block that includes invalid RPMB data. In some implementations, the memory controller can record an indication bit (e.g., purge_data_bit) corresponding to each memory block, where the indication bit indicates whether the corresponding memory block has invalid RPMB data. For example, the indication bit being 1 indicates that the corresponding memory block has invalid RPMB data, and the indication bit being 0 indicates that the corresponding memory block does not have invalid RPMB data.

As an example, first RPMB data (e.g., a password) is associated with the logical address LBA0 and is written to a first memory block (Block A). Second RPMB data (e.g., an updated password) is written to the same logical address LBA0 to replace the first RPMB data. That is, the second RPMB data is also associated with the logical address LBA0. The second RPMB data is written to a second memory block (Block B). As such, the first RPMB data becomes invalid, and the indication bit corresponding to the first memory block flips from 0 to 1.

In some implementations, indications bits corresponding to memory blocks in the memory device (e.g., in the form of a bit map) are stored in a storage medium (e.g., RAM 504 of FIG. 5A) of the memory controller. The indication bits can be sent to the memory device for storage on a regular basis, to prevent data loss due to unexpected power outages.

In some implementations, the indication bits can be used to indicate whether the corresponding memory blocks have another type of specific data (e.g., secure data, authentication data, or priority data) that is invalid, other than RPMB data.

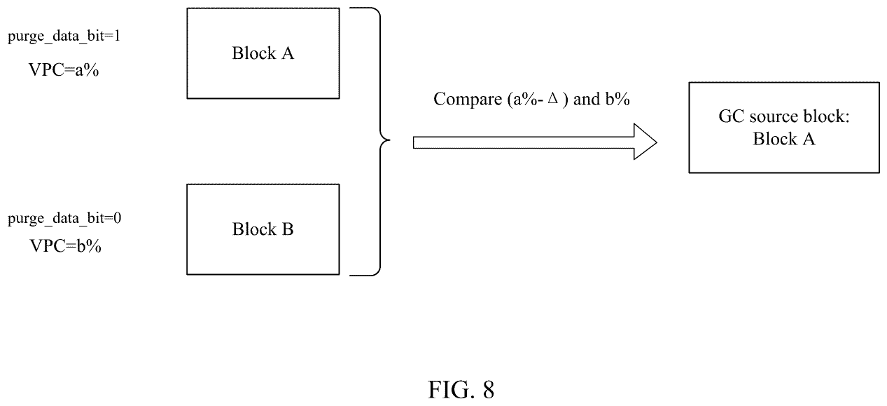

FIG. 8 illustrates example techniques to perform garbage collection based on priority levels of memory blocks. In some implementations, the memory controller can identifying a memory block that has invalid RPMB data by checking the indication bits. The memory controller can further increase a priority level of the memory block. As such, when the memory controller performs garbage collection based on priority levels of memory blocks, the memory block with the increased priority level has a greater chance of being erased, and/or can be erased earlier than memory blocks have lower priority levels.

For example, the memory controller performs garbage collection based on VPC of memory blocks, where a memory block having a smaller VPC is erased earlier than a memory block having a greater VPC. As shown in FIG. 8, by checking the indication bits, the memory controller identifies the first memory block (Block A) as a memory block that has invalid RPMB data, and identifies the second memory block (Block B) as a memory block that does not have invalid RPMB data. VPC of the first memory block and the second memory block are a % and b %, respectively, where a>b. The memory controller increases the priority level of Block A by decreasing its VPC by a value Δ, so that the VPC of Block A becomes (a %-Δ). In some implementations, the memory controller can decide whether to first perform garbage operation on Block A or Block B by comparing a difference between a % and b % (i.e., (a %-b %)) and the threshold Δ. If (a %-b %)<Δ, the memory controller performs garbage collection on Block A before Block B. After erasing Block A, the indication bit corresponding to Block A flips from 1 to 0. If (a %-b %)≥Δ, the memory controller performs garbage collection on Block B before Block A. In some implementations, the memory controller can decide whether to first perform garbage operation on Block A or Block B by comparing (a %-Δ) and b %. If (a %-Δ)<b %, the memory controller performs garbage collection on Block A before Block B. After erasing Block A, the indication bit corresponding to Block A flips from 1 to 0. If (a %-Δ)≥b %, the memory controller performs garbage collection on Block B before Block A.

VPC of all memory blocks having invalid RPMB data can be decreased by the same value Δ. As such, when the memory controller determines the order of memory blocks to perform garbage collection on, memory blocks having invalid RPMB data can in general move up in the order. In some implementations, to determine a next memory block to perform garbage collection on, the memory controller can select the memory block (e.g., Block C, VPC of Block C is c %) with the smallest VPC from a first group of memory blocks whose corresponding indication bit is 1, and select the memory block (e.g., Block D, VPC of Block D is d %) with the smallest VPC from a second group of memory blocks whose corresponding indication bit is 0. By comparing (c %-Δ) and d %, the memory controller can determine the next memory block to perform garbage collection on. In some implementations, to determine a next memory block to perform garbage collection on, the memory controller can decrease the VPC of all memory blocks whose indication bit is 1 by Δ, and select the lowest VPC among VPCs of both groups of memory blocks.

The value Δ can be pre-determined with considerations such as life time (e.g., E/P cycle) and performances (e.g., read speed and write speed) of the memory device. As an example, the value Δ can be set between 5% and 10%, or at other suitable percentage or number. In some implementations, the memory controller can adjust the value Δ over time, e.g., as the memory device progresses into later E/P cycles.

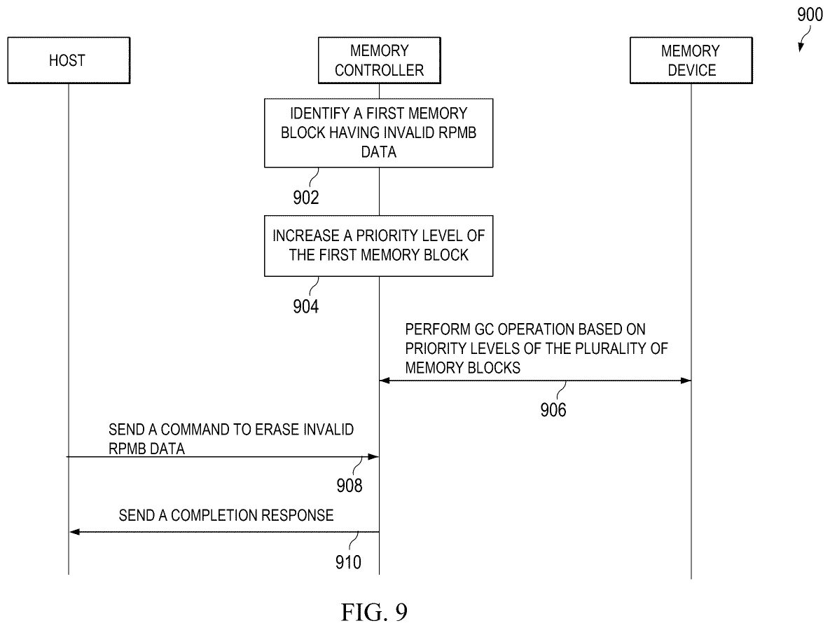

FIG. 9 illustrates a swimlane diagram of an example process 900 of processing a command, such as a purge command. The example process 900 can be performed by a memory system (e.g., the memory system 102 of FIG. 1) coupled to a host (e.g., the host 108 of FIGS. 1 and 5A). The memory system can include a memory controller (e.g., the memory controller 106 of FIGS. 1-2B and 5A-5B) and a memory device (e.g., the memory device 104 of FIGS. 1-2B and 5A, and the memory device 300 of FIGS. 3-4) including a plurality of memory blocks (e.g., memory blocks 304 of FIG. 3).

The operations shown in process 900 may not be exhaustive and that other operations can be performed as well before, after, or in between any of the illustrated operations. Further, some of the operations may be performed simultaneously, or in a different order than shown in FIG. 9. In some implementations, some of the operations may be performed by or one or more components of a device or a system, such as, a memory controller, or a peripheral circuit of the memory device.

At 902, the memory controller identifies a first memory block that has invalid RPMB data, for example, by checking indication bits corresponding to the plurality of memory blocks.

At 904, the memory controller increases a priority level of the first memory block. The memory controller can be perform garbage collection based on priority levels of the plurality of memory blocks, where a memory block with a higher priority level is erased earlier than a memory block with a lower priority level. In some implementations, priority levels are determined based on VPC of each memory block. A memory block having a smaller VPC has a higher priority level. The memory controller can increase the priority level of the first memory block by decreasing the VPC of the first memory block.

At 906, the memory controller performs garbage collection (e.g., background garbage collection) on the memory device based on priority levels of the plurality of memory blocks. As such, the first memory block with an increased priority level has a greater chance of being erased during the garbage collection, compared to the scenario where the priority level of the first memory block is unchanged. In some implementations, to perform garbage collection on the first memory block, the memory controller sends one or more read commands to read valid data from the first memory block, and sends one or more write commands to write valid data to a target memory block (e.g., a free memory block). The first memory block can then be erased. During the process of migrating data from the first memory block to the target memory block, VPC of the first memory block is updated to reflect the amount of valid data left in the first memory block. If the current garbage collection does not last long enough to migrate all valid data from the first memory block, the priority level of the first memory block will increase in the next garbage collection, as VPC of the first memory block will have decreased.

At 908, the host sends a command that indicates to physically erase invalid certain data (e.g., invalid RPMB data) in the memory device. For example, the command can be a purge command. Since the memory blocks (e.g., the first memory block) having invalid RPMB data have a greater chance of being erased before receiving the command during the garbage collection at operation 906, less invalid RPMB data remains to be erased after receiving the command. As such, the time needed to process the command can be reduced.

In some implementations, all of the invalid RPMB data is erased during garbage collection at operation 906 (e.g., while the memory device is idle and/or before receiving a purge command), so that indication bits of all memory blocks show as 0, which indicates that no memory block has invalid RPMB data. In such case, at 910, the memory controller sends a response to the host to inform the host that invalid RPMB data has been erased, and that the command received at 908 is completed.

In some implementations, a portion of the invalid RPMB data is erased during garbage collection at operation 906, while a portion of the invalid RPMB data remains to be erased. Indication bits corresponding to memory blocks that no longer have invalid RPMB data show as 0. Indication bits corresponding to memory blocks that still have invalid RPMB data show as 1. In such case, the memory controller can migrate valid data from the memory blocks with indication bits being 1 to one or more target memory blocks, and erase these memory blocks. After erasing all invalid RPMB data, at 910, the memory controller sends a response to the host to inform the host that invalid RPMB data has been erased, and that the command received at 908 is completed.

The present disclosure also provides a non-transitory computer-readable storage medium. The non-transitory computer-readable storage medium stores one or more instructions (e.g., firmware of a memory controller) that are executable by a computer system. When being executed by the computer system, the instructions in the storage medium can implement method for processing commands (e.g., purge commands) in a memory system as discussed with reference to FIGS. 1-9.

The non-transitory computer-readable storage medium can be an internal storage unit of the device described in any of the foregoing embodiments. For example, the non-transitory computer-readable storage medium can be a hard disk or an internal memory of the device. The non-transitory computer-readable storage medium can also be an external storage device of the device, such as a plug-in hard disk, a smart media card (SMC), a secure digital (SD) card, a flash card, etc. Further, the non-transitory computer-readable storage medium can also include an internal storage unit and an external storage device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A memory system, comprising:
a memory device comprising a plurality of memory blocks; and
a memory controller coupled to the memory device, wherein the memory controller is configured to:
identify a first memory block of the plurality of memory blocks, wherein the first memory block comprises specific data that is invalid;
increase a priority level of the first memory block among the plurality of memory blocks; and
perform garbage collection on the memory device based on priority levels of the plurality of memory blocks.

2. The memory system of claim 1, wherein the specific data comprises replay-protected-memory-block (RPMB) data.

3. The memory system of claim 1, wherein the specific data becomes invalid when new data is written to a same logical address as the specific data.

4. The memory system of claim 1, wherein the memory controller is configured to:
identify the first memory block by checking an indication bit corresponding to the first memory block,
wherein the indication bit indicates whether the first memory block comprises the specific data that is invalid.

5. The memory system of claim 1, wherein the memory controller is configured to:
increase the priority level of the first memory block by decreasing a first valid page count (VPC) of the first memory block; and
perform a first garbage collection operation on the first memory block before a second memory block having a second VPC that is greater than the first VPC.

6. The memory system of claim 1, wherein the memory controller is configured to:
receive a purge command to erase invalid specific data in the memory device; and
send a response indicating that the invalid specific data in the memory device have been erased.

7. The memory system of claim 6, wherein the memory controller is configured to:
erase the invalid specific data in a corresponding memory block during the garbage collection before receiving the purge command.

8. The memory system of claim 1, wherein the memory controller is configured to:
perform the garbage collection on the memory device while the memory device is idle.

9. The memory system of claim 1, wherein the memory controller is configured to:
perform a first garage collection operation on the first memory block by sending one or more commands to migrate valid data from the first memory block to a target memory block of the memory device and erase the first memory block.

10. A memory controller, comprising:
a processor; and
a first interface configured to be coupled to a memory device,
wherein the processor is configured to perform garbage collection on the memory device based on priority levels of a plurality of memory blocks in the memory device, and
wherein the first interface is configured to:
send one or more read commands to read valid data from a first memory block of the plurality of memory blocks, wherein the first memory block comprises specific data that is invalid, and wherein, among the plurality of memory blocks, the first memory block has an increased priority level based on the first memory block comprising the specific data that is invalid; and
send one or more write commands to write the valid data read from the first memory block to a target memory block of the memory device.

11. The memory controller of claim 10, wherein the processor is configured to:
identify the first memory block from the plurality of memory blocks; and
increase a priority level of the first memory block among the plurality of memory blocks.

12. The memory controller of claim 11, wherein the processor is configured to:
increase the priority level of the first memory block by decreasing a first valid page count (VPC) of the first memory block; and
perform a first garbage collection operation on the first memory block before a second memory block having a second VPC that is greater than the first VPC.

13. The memory controller of claim 10, wherein the memory controller comprises a second interface coupled to a host, wherein the second interface is configured to:
receive a purge command to erase invalid specific data in the memory device; and
send a response indicating that the invalid specific data in the memory device have been erased.

14. The memory controller of claim 13, wherein the processor is configured to erase the invalid specific data in a corresponding memory block during the garbage collection before receiving the purge command.

15. The memory controller of claim 10, wherein the processor is configured to perform the garbage collection on the memory device while the memory device is idle.

16. The memory controller of claim 10, wherein the specific data comprises replay-protected-memory-block (RPMB) data.

17. The memory controller of claim 10, wherein the specific data becomes invalid when new data is written to a same logic address as the specific data.

18. The memory controller of claim 10, wherein the processor is configured to:
identify the first memory block by checking an indication bit corresponding to the first memory block, wherein the indication bit indicates whether the first memory block comprises the specific data that is invalid.

19. The memory controller of claim 10, wherein the processor is configured to:
perform a first garage collection operation on the first memory block by sending one or more commands to migrate valid data from the first memory block to a target memory block of the memory device and erase the first memory block.

20. A method of operating a memory system, comprising:
identifying a first memory block of a plurality of memory blocks of a memory device of the memory system, wherein the first memory block comprises specific data that is invalid;
increasing a priority level of the first memory block among the plurality of memory blocks; and
performing garbage collection on the memory device based on priority levels of the plurality of memory blocks.
